(19) United States
(12) Patent Application Publication
(10) Pub. No.: US 2007/0035502 A1
(43) Pub. Date: Feb. 15, 2007

(54) Liquid crystal display device, method for controlling display data for liquid crystal display device, and recording media

(75) Inventor: Seiji Kawaguchi, Hirakata-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Toshiba Matsushita Display Technology Co., Ltd., Tokyo (JP)

(21) Appl. No.: 11/500,959

(22) Filed: Aug. 9, 2006

(30) Foreign Application Priority Data
Aug. 10, 2005 (JP) 2005-231805

(51) Int. Cl. G09G 3/36

(52) U.S. Cl. 345/98

(57) ABSTRACT

A liquid crystal display device which enables a reduction in power consumption at low cost, includes: a liquid crystal display panel having signal lines and scan lines arranged in a matrix; a gate driver configured to supply a gate signal to any of the scan lines; a source driver having a shift register which outputs video data during a video display period, a second data storing section configured to store second data which are applied to each of the pixel electrodes and which are independent of the video data, and a D/A converting section configured to execute a D/A conversion on the data acquired from the shift register and the second data storing section and to supply a voltage to the signal line; and a timing control section configured to control a timing at which the video data from an input video signal is inputted to the shift register, a timing at which the D/A converting section acquires the video data from the shift register, and a timing at which the D/A converting section acquires the second data from the second data storing section.

### BACKGROUND OF THE INVENTION

1. Field of the Invention

The present invention relates to a liquid crystal display device, a method for controlling display data for the liquid crystal display device, and recording media for the liquid crystal display device. The present invention relates to a liquid crystal display device using, for example, an OCB mode liquid crystal, a method for controlling display data for the liquid crystal display device, and recording media for the liquid crystal display device.

2. Related Art

Liquid crystal display devices are thin, light, and are expected to replace conventional cathode-ray tubes. Thus, the applications of liquid crystal display devices have been increasingly expanded. However, currently popular TN (Twisted Nematic) oriented liquid crystal panels offer small view angles, low response speeds, and may show unwanted trails during motion picture display. Thus, these liquid crystal panels offer lower image quality than cathode-ray tubes.

In recent years, increasingly extensive use has been made of a liquid crystal display device comprising a liquid crystal display element in an OCB (Optically Compensated Birefringence) mode characterized by a high response speed and a large view angle. The liquid crystal in this liquid crystal display device use bend alignment for visual compensations. This is further combined with an optical phase compensation film to provide a larger view angle.

FIG. 6 is a sectional view schematically showing how liquid crystal molecules in the OCB mode liquid crystal display element are oriented. FIGS. 6(A) and 6(B) are sectional views showing a voltage application state. FIG. 6(C) is a sectional view showing a voltage non-application state.

A Nematic liquid crystal, shown as liquid crystal molecules 92 in FIG. 6(A) and others, is injected between glass substrates 91 of a liquid crystal display panel constituting the liquid crystal display device using the OCB mode liquid crystal display element. The orientation of the liquid crystal in the voltage non-application state is called a spray alignment 93. When the liquid crystal display device using the OCB mode liquid crystal display element is powered on, driving called transition driving needs to be executed. The transition driving involves applying a relatively high voltage of about 20 to 25 V to the liquid crystal layer when the liquid crystal display device is powered on, to change the spray alignment 93, shown in FIG. 6(C), to bend alignments 94a and 94b shown in FIGS. 6(A) and 6(B). The use of the bend alignments 94a and 94b for display is characteristic of the liquid crystal display device using the OCB mode liquid crystal display element. The voltage is increased or reduced to change the bend alignment and thus the transmittance of the panel.

The bend alignment 94a, shown in FIG. 6(A), corresponds to white display. The bend alignment 94b, shown in FIG. 6(B), corresponds to black display.

With the liquid crystal display device using the OCB mode liquid crystal display element, when a voltage of at most 2 V is continuously applied to the liquid crystal display panel, the orientation of the liquid crystal transfer from the bend alignment 94a or 94b to the spray alignment 93 gradually. To prevent such transferring from the bend alignment to the spray alignment, the liquid crystal display device using the OCB mode liquid crystal display element executes driving called the driving to prevent transferring from the bend alignment to the spray alignment.

Specifically, for a liquid crystal display device in a normally white mode in which white display is provided during application of a relatively low voltage, while black display is provided during application of a relatively high voltage, the driving to prevent transferring from the bend alignment to the spray alignment applies a voltage corresponding to black in addition to a video signal periodically displayed at each pixel to prevent transferring from the bend alignment to the spray alignment. The driving to prevent transferring from the bend alignment to the spray alignment includes double speed conversion involving alternate performance of an operation of applying a voltage corresponding to black to each pixel in order to prevent transferring from the bend alignment to the spray alignment and an operation of applying a voltage corresponding to a video signal to the pixel (see, for example, Japanese Patent Laid-Open No. 2003-280617). Accordingly, with the liquid crystal display device using the OCB mode liquid crystal display element, a period during which a video for one frame (or one field) is displayed includes a display period during which the voltage corresponding to the video signal is applied to each pixel and a black insertion period during which the voltage corresponding to black is applied to the pixel in order to prevent transferring from the bend alignment to the spray alignment.

A description will be given below of the driving to prevent transferring from the bend alignment to the spray alignment operation based on the double speed conversion.

FIG. 7 shows an exemplary timing chart for a video signal, a double speed signal, and a gate pulse during the driving to prevent transferring from the bend alignment to the spray alignment based on the double speed conversion.

A video signal input as RGB data is stored in a shift register of a source driver so that for each one horizontal period (1H period), data on a black gray level for black insertion is stored before the 1H period, while the RGB data constituting the video signal converted to have a double speed is stored after the 1H period. A shaded part in FIG. 7 indicates the black gray level data for black insertion.

For each 1H period, data on the pixels in one line are sequentially input to the shift register. The source driver simultaneously outputs data on the pixels in one line. Consequently, as shown in FIG. 7, the data is outputted by the source driver 1H period later than the input video signal.

G1 to G10 in FIG. 7 denote gate signals output to gate lines by a gate driver. Reference characters shown to the right of each gate signal denote a display signal or black insertion data (B), which is written to a picture cell when the corresponding gate signal becomes high.

When a display signal S1 is outputted by the source driver, the gate signal on a gate line G1 becomes high. The display signal S1 is written to a picture cell on the gate line G1. Then, when black insertion data inserted between the display signal S1 and a display signal S2 is outputted by the source driver, a gate signal on a gate line G7 becomes high. The black insertion data is written to a picture cell on the gate line G7. Then, when a display signal S2 is outputted by the source driver, a gate signal on a gate signal G2 becomes high. The display signal S2 is written to a picture cell on the gate line G2. Then, when black insertion data inserted between the display signal S2 and a display signal S3 is outputted by the source driver, a gate signal on a gate line G8 becomes high. The black insertion data is written to the picture cell on the gate line G8. A similar process is subsequently executed so that a display signal or black insertion data is written to each picture cell when a gate signal on the corresponding gate line becomes high.

Thus, each of the gate lines G1 to G10 is selected twice during one field period. A display signal and black insertion data are written once to the picture cell on each of the gate lines G1 to G10. This achieves the driving to prevent transferring from the bend alignment to the spray alignment that writes a display signal, while periodically writing black insertion data.

As a result, in the example shown in FIG. 7, the ratio of a video display period T1 to a black insertion period T2 is set at 9:11. The ratio of the video display period T1 to the black insertion period T2 can be adjusted by varying timings for the pulses of gate signals on the gate lines G1 to G10 at which a display signal is written and at which black insertion data is written.

FIG. 8 is a block diagram of a liquid crystal display device that executes the conventional driving to prevent transferring from the bend alignment to the spray alignment based on the double speed conversion. FIG. 9 is a timing chart showing the flow of display data during execution, by the liquid crystal display device in FIG. 8, of the driving to prevent transferring from the bend alignment to the spray alignment based on the double speed conversion.

The liquid crystal display device comprises a liquid crystal display panel 110, a source driver 111, a gate driver 112, a controller 113, an input power source 114, and a liquid crystal driving voltage generating circuit 115.

The liquid crystal display panel 110 has signal lines and scan lines arranged in a matrix, with OCB mode liquid crystal display elements each provided at the intersection point between each pair of a signal and scan lines.

The gate driver 112 supplies a gate signal to a scan line in the liquid crystal display panel 110. The source driver 111 supplies a voltage corresponding to display data to a signal line in the liquid crystal display panel 110.

The input power source 114 supplies power to the controller 113 and liquid crystal driving voltage generating circuit 115. The liquid crystal driving voltage generating circuit 115 adjusts voltages supplied to the liquid crystal display panel 110, source driver 111, and gate driver 112 according to the timing at which display data is displayed on the liquid crystal display panel 110.

The controller 113 comprises a signal processing section 131, a line memory 133, and a timing control section 132. The source driver 111 comprises a D/A converter 121 and a shift register 122. The signal processing section 131 of the controller 113 has a black gray level storing section 134. The black gray level storing section 134 is a storage element such as an EEPROM in which the gray level information of black display data to be inserted for preventing transferring from the bend alignment to the spray alignment is stored.

Now, with reference to FIGS. 8 and 9, a detailed description will be given of the driving to prevent transferring from the bend alignment to the spray alignment operation based on the double speed conversion.

A video signal composed of RGB data is input to the signal processing section 131, which then executes a gray level or gamma correction process on the input video signal, which then converts the signal into a double-speed one, and then stores the converted signal in the line memory 133. As shown in FIG. 9, each data for one horizontal period (1H period) is stored in the line memory 133 so that black data for black insertion is stored before the 1H period, while the double-speed video signal is stored after the 1H period. On this occasion, the signal processing section 131 generates black data for black insertion to be stored before the 1H period, on the basis of gray level information stored in the black gray level storing section 134. The signal processing section 131 then stores the black data in the line memory 133.

The timing control section 132 of the controller 113 outputs a start pulse when inputting of display signals (S1 to S4) contained in the video signal is started. This allows the start of a transfer of data on one-line pixels stored in the line memory 133 to the shift register 122 of the source driver 111. Here, a double-speed clock allows the data on one-line pixels to be sequentially transferred from the line memory 133 to the shift register 122 at a double speed.

Then, the timing control section 132 of the controller 113 outputs a load pulse to the D/A converter 121 of the source driver 111 before the output of a start pulse for starting the transfer of the next display signal contained in the video signal. At the time of input of the load pulse, the D/A converter 121 simultaneously acquires data on one-line pixels stored in the shift register 122, executes a D/A conversion on the data, and outputs a voltage corresponding to each display data to a signal line in the liquid crystal display panel 110.

The load pulse is outputted immediately before the next display signal is inputted. Consequently, the timing at which the data is outputted from the source driver 111 to a signal line in the liquid crystal display panel 110 is 1H later timing than the video signal that has been input to the controller 113, as shown in FIG. 9.

The driving to prevent transferring from the bend alignment to the spray alignment based on the double speed conversion is thus executed.

In the above description, the double-speed conversion driving is used to achieve black data insertion in order to prevent transferring from the bend alignment to the spray alignment of the OCB mode liquid crystal. However, the double-speed conversion driving described in FIGS. 9 to 11 is used not only to prevent transferring from the bend alignment to the spray alignment of the OCB mode liquid crystal, but also to improve the motion picture quality.

To improve the motion picture quality, the above double-speed conversion driving can also be used for a liquid crystal display device using a liquid crystal different from the OCB mode liquid crystal, for example, a liquid crystal display device using a TN oriented liquid crystal display panel. The double-speed conversion driving allows black data to be inserted and displayed during the display of display data, thus suppressing, for example, the phenomenon in which unwanted trails are viewed during motion picture display.

To improve the motion picture quality with the liquid crystal display device using the OCB mode liquid crystal, the ratio of the black insertion period (length of a period T2 in FIG. 7) is set longer than in the case where the double-speed conversion driving is used only to prevent transferring from the bend alignment to the spray alignment.

However, the above conventional double-speed conversion driving requires the controller 113 to execute a double-speed converting process. Further, the line memory 133 transfers display data to the shift register 122 at a high speed. This requires the controller 113 and source driver 111 to consume a large amount of power.

Furthermore, since the signal processing section 131 needs to execute a double-speed converting process at a high speed, the controller 113 needs to exhibit high performance and the line memory 133 must be provided. This increases costs.

With an increase in the rate at which data is transferred from the line memory 133 to the shift register 122, noise may disadvantageously result from the high frequency of the data transfer. In fact, for high-pixel panels, efforts are made to reduce the transfer rate using a well known technique, for example, by doubling the width of a transfer bus to the source driver. It is undesirable to simply double a clock for the high-pixel panel.

### SUMMARY OF THE INVENTION

The present invention solves these conventional problems. An object of the present invention is to provide a liquid crystal display device, a method for controlling display data for the liquid crystal display device, and the like which enable a reduction in power consumption.

The present invention also relates to a program which allows a computer to function so as to execute the output timing control step of controlling timings such that during the video display period, a D/A conversion is executed on the video data stored in the shift register so as to allow the first voltage to be supplied to a signal line and such that during the predetermined period, a D/A conversion is executed on the second data stored in a second data storing section so as to allow the second voltage to be supplied to a signal line.

The present invention can provide a liquid crystal display device, a method for controlling display data for the liquid crystal display device, and the like, which enables a reduction in power consumption.

In an embodiment of the present invention, a liquid crystal display device includes:

a liquid crystal display panel having signal lines and scan lines arranged in a matrix, and pixel electrodes each provided in association with an intersection point between the corresponding signal line and scan line;

a gate driver configured to supply a gate signal to any of the scan lines;

a source driver having a shift register to which video data to be displayed during a video display period is sequentially input, the video data corresponding to pixels in one line, the shift register configured to simultaneously output video data corresponding to pixels in one line, a second data storing section that stores second data which are applied to each of the pixel electrodes and which are independent of the video data, and a D/A converting section configured to execute a D/A conversion on the video data acquired from the shift register and the second data acquired from the second data storing section and to supply a voltage to the signal line; and

a timing control section configured to control a first timing at which the video data contained in an input video signal is inputted to the shift register, to control a second timing at which the D/A converting section acquires the video data from the shift register and executes a D/A conversion on the video data and supplies a voltage to the signal line, and to control a third timing at which the D/A converting section acquires the second data from the second data storing section, executes a D/A conversion on the second data, and supplies a voltage to the signal line.

In another embodiment of the present invention, the second data allows at least one of a plurality of different predetermined gray levels to be displayed.

In another embodiment of the present invention, the second data is black data to be displayed during a black insertion period in a normally white mode.

In another embodiment of the present invention, a liquid crystal used in the liquid crystal display panel is an OCB mode liquid crystal.

In another embodiment of the present invention, the liquid crystal display device further includes a second data generating section that generates the second data, wherein the timing control section is configured to control such that the second data generated by the second data generating section is inputted to the second data storing section during a blanking period of the input video signal.

In another embodiment of the present invention, the second data generating section generates the second data from individually set gray level data on R, G, and B.

In another embodiment of the present invention, the liquid crystal display device further includes a second data generating section which, when a power supply is turned on, is configured to generate and input the second data to the second data storing section regardless of the input of the video signal.

In another embodiment of the present invention, the second data generating section is configured to generate the second data from individually set gray level data on R, G, and B.

In another embodiment of the present invention, the second data in the second storing section is pre-stored.

Another embodiment of the present invention is a method for controlling display data for a liquid crystal display device including a liquid crystal display panel having signal lines and scan lines arranged in a matrix, and pixel electrodes each provided in association with an intersection point between the corresponding signal line and scan line, a gate driver configured to supply a gate signal to any of the scan lines, and a source driver configured to supply a first voltage, corresponding to a gray level in video data, to the signal line during a video display period and to supply a second voltage, corresponding to a gray level in second data independent of the video data, to the signal line during a predetermined period containing no video display period, the method comprising:

a video data input timing control step of controlling a timing at which the video data contained in an input video signal is inputted to a shift register provided in the source driver and to which the video data to be displayed during the video display period is sequentially inputted, the video data corresponding to pixels in one line, the shift register simultaneously outputting video data corresponding to pixels in one line; and

an output timing control step of controlling timings such that during the video display period, a D/A conversion is executed on the video data stored in the shift register to allow the first voltage to be supplied to the signal line, and such that during the predetermined period a D/A conversion is executed on the second data stored in a second data storing section provided in the source driver to allow the second voltage to be supplied to the signal line.

In another embodiment of the present invention, in the method for controlling display data for a liquid crystal display device, the second data allows at least one of a plurality of different predetermined gray levels to be displayed.

In another embodiment of the present invention, in the method for controlling display data for a liquid crystal display device, the second data is black data to be displayed during a black insertion period in a normally white mode.

In another embodiment of the present invention, in the method for controlling display data for a liquid crystal display device, a liquid crystal used in the liquid crystal display panel is an OCB mode liquid crystal.

In another embodiment of the present invention, a computer readable storage medium on which a program is recorded, which when the program is executed, allows a computer to function to execute the output timing control step of controlling timings such that during the video display period, a D/A conversion is executed on the video data stored in the shift register to allow the first voltage to be supplied to the signal line and such that during the predetermined period, a D/A conversion is executed on the second data stored in a second data storing section so as to allow the second voltage to be supplied to the signal line, the output timing control step being included in the method for controlling display data for a liquid crystal display device.

### BRIEF DESCRIPTION OF THE DRAWINGS

A more complete appreciation of the invention and many of the attendant advantages thereof will be readily obtained as the same becomes better understood by reference to the followings detailed description in connection with the accompanying drawings, wherein:

FIG. 1 is an exemplary block diagram showing the configuration of a liquid crystal display device according to Embodiment 1 of the present invention;

FIG. 2 is an exemplary timing chart showing the flow of display data during the driving to prevent transferring from the bend alignment to the spray alignment executed by the liquid crystal display device according to Embodiment 1 of the present invention;

FIG. 3 is an exemplary block diagram showing another configuration of the liquid crystal display device according to Embodiment 1 of the present invention;

FIG. 4 is an exemplary block diagram showing the configuration of a liquid crystal display device according to Embodiment 2 of the present invention;

FIG. 5 is an exemplary timing chart showing the flow of display data during the driving to prevent transferring from the bend alignment to the spray alignment executed by the liquid crystal display device according to Embodiment 2 of the present invention;

FIG. 6(A) is a diagram showing a bend alignment of an OCB liquid crystal for white display, FIG. 6(B) is a diagram showing a bend alignment of the OCB liquid crystal for black display, and FIG. 6(C) is a diagram showing a spray alignment of the OCB liquid crystal;

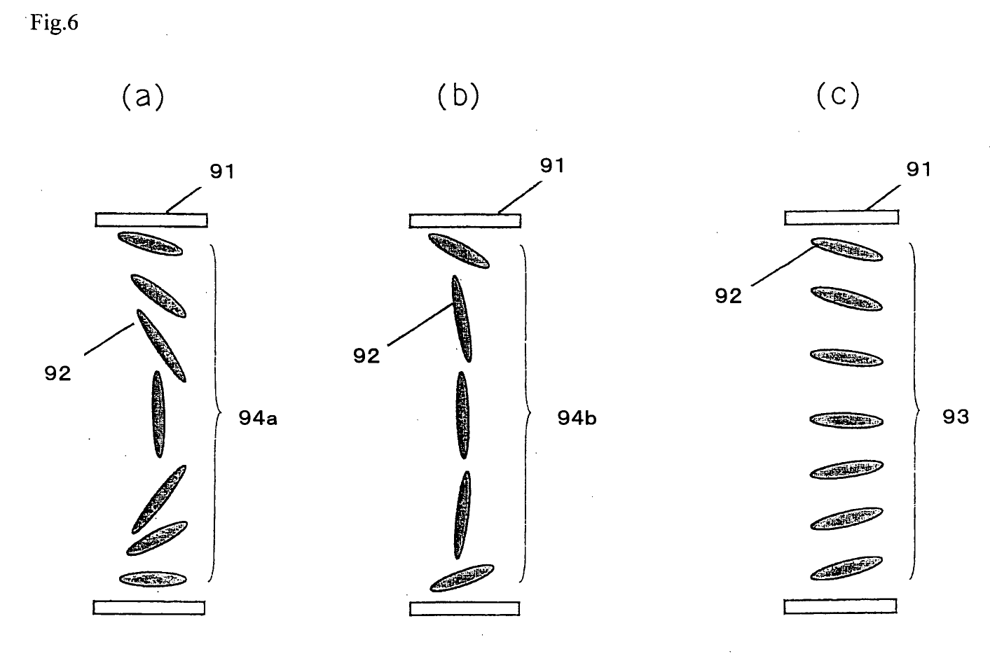

FIG. 7 is a diagram of an exemplary timing chart of a video signal, a double-speed signal, and a gate pulse during the driving to prevent transferring from the bend alignment to the spray alignment based on double-speed conversion, the driving being executed by a conventional liquid crystal display device;

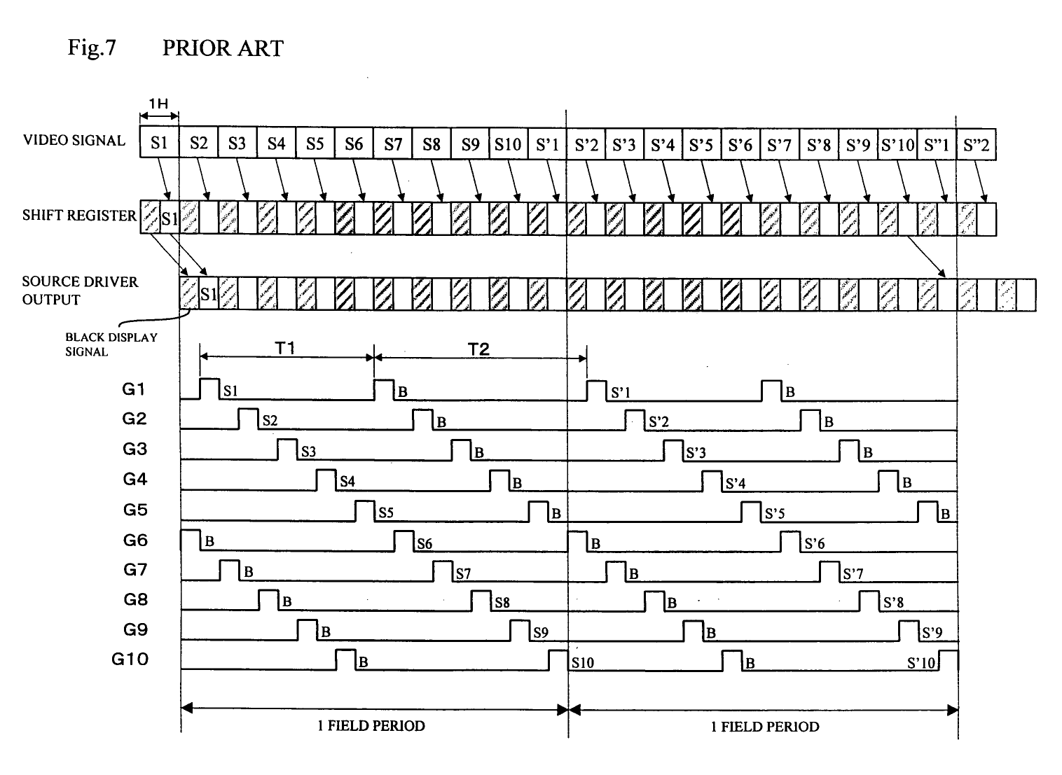

FIG. 8 is a block diagram of a conventional liquid crystal display device that execute the driving to prevent transferring from the bend alignment to the spray alignment based on the double-speed conversion; and

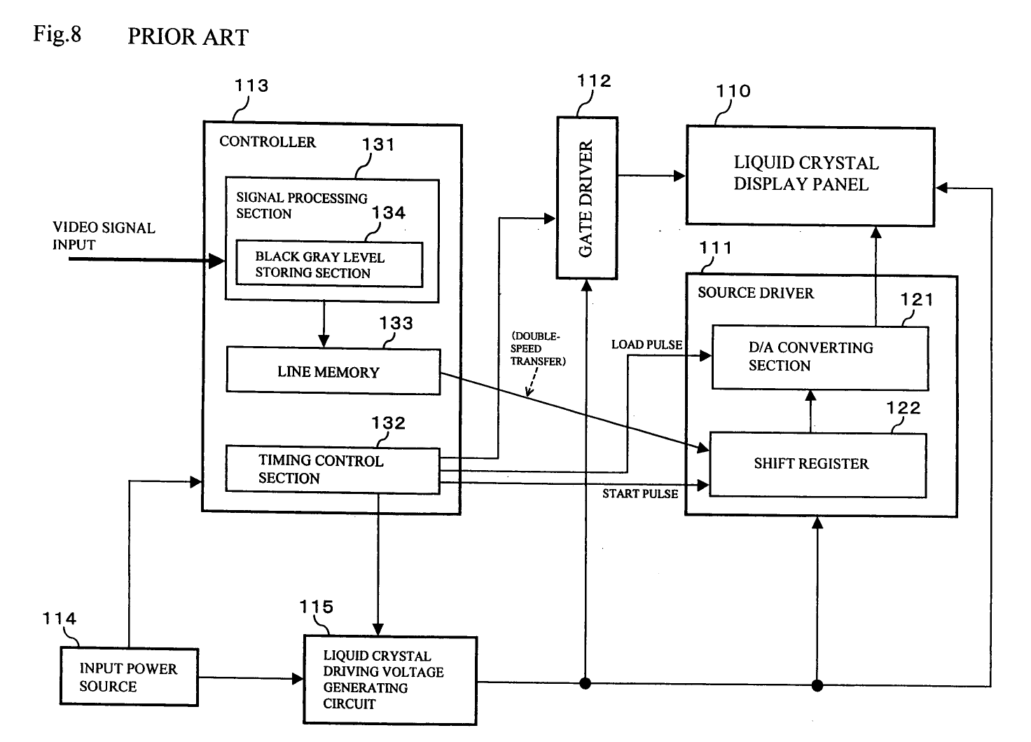

FIG. 9 is a timing chart showing the flow of display data during the driving to prevent transferring from the bend alignment to the spray alignment based on the double-speed conversion, the driving being executed by conventional liquid crystal display device.

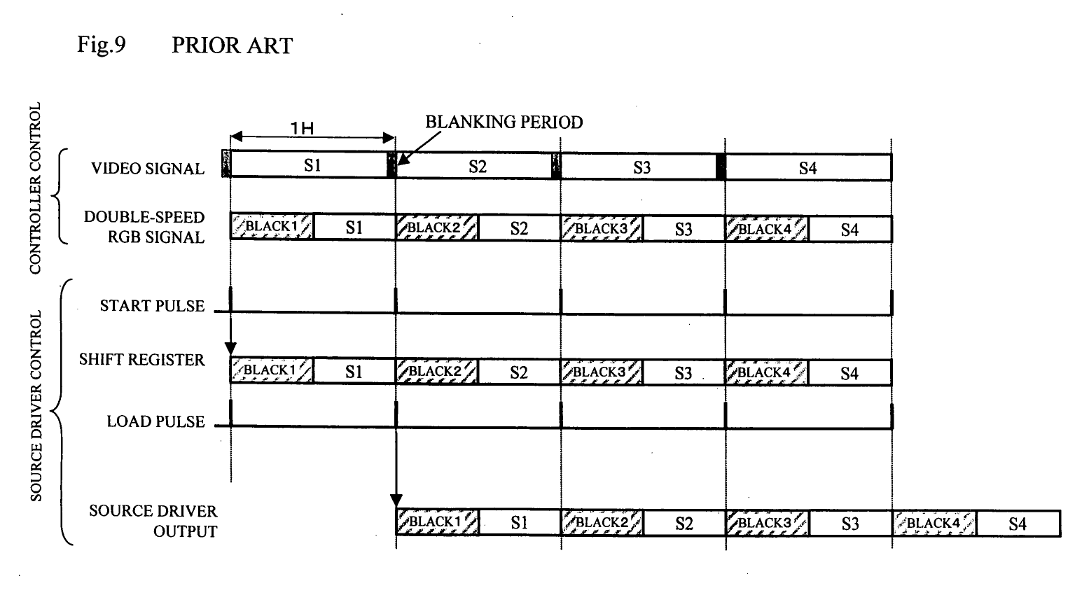

### DESCRIPTION OF SYMBOLS

10 Liquid crystal display panel
11 Source driver
12 Gate driver
Controller
Input power source
Liquid crystal driving voltage generating circuit
D/A converting section
Shift register
Black display register
Black data storing section
31, 34, 35 Signal processing section
32 Timing control section
33 Black gray level storing section

### DETAILED DESCRIPTION OF THE PREFERRED EMBODIMENTS

Non-timing embodiments of the present invention will be described below with reference to the drawings.

(Embodiment 1)

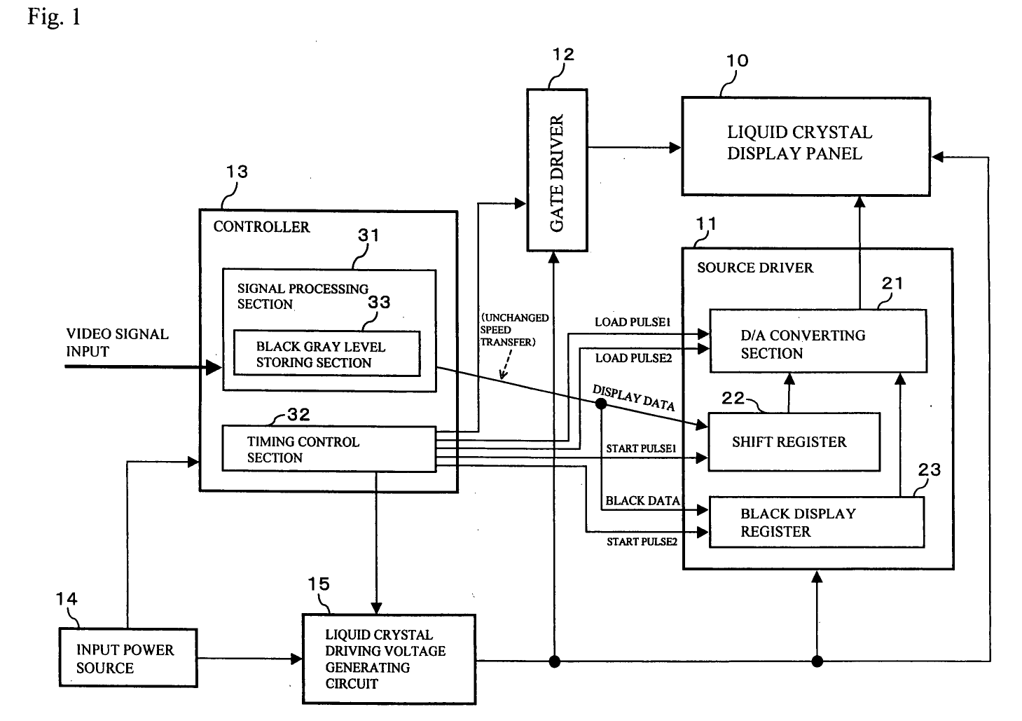

FIG. 1 is a block diagram showing the configuration of a liquid crystal display device according to Embodiment 1 of the present invention.

The liquid crystal display device of Embodiment 1 comprises a liquid crystal display panel 10, a source driver 11, a gate driver 12, a controller 13, an input power source 14, and a liquid crystal driving voltage generating circuit 15.

The liquid crystal display panel 10 has signal lines and scan lines arranged in a matrix, with pixel electrodes and OCB mode liquid crystal display elements each provided at the intersection point between each pair of signal and scan lines.

The gate driver 12 supplies a gate signal to a scan line in the liquid crystal display panel 10. The source driver 11 supplies a voltage corresponding to display data to a signal line in the liquid crystal display panel 10.

The input power source 14 supplies power to the controller 13 and liquid crystal driving voltage generating circuit 15. The liquid crystal driving voltage generating circuit 15 adjusts voltages supplied to the liquid crystal display panel 10, source driver 11, and gate driver 12 according to the timing at which display data is displayed on the liquid crystal display panel 10.

The controller 13 comprises a signal processing section 31 and a timing control section 32. The source driver 11 comprises a D/A converter 21, a shift register 22, and a black display register 23. The signal processing section 31 of the controller 13 has a black gray level storing section 33. The black gray level storing section 33 is a storage element, such as an EEPROM, in which the gray level information of black display data to be inserted for preventing transferring from the bend alignment to the spray alignment is stored. The gray level information of the black display data stored in the black gray level storing section 33 is individually set for R, G, and B. The storage element, such as an EEPROM, stores set values for each register and data required to change driving timings, in addition to the gray level information of the black display data.

The black display data inserted for preventing transferring from the bend alignment to the spray alignment corresponds to an example of second data according to the present invention. The black display register 23 corresponds to an example of a second data storing section according to the present invention. The signal processing section 31 corresponds to an example of a second data generating section according to the present invention.

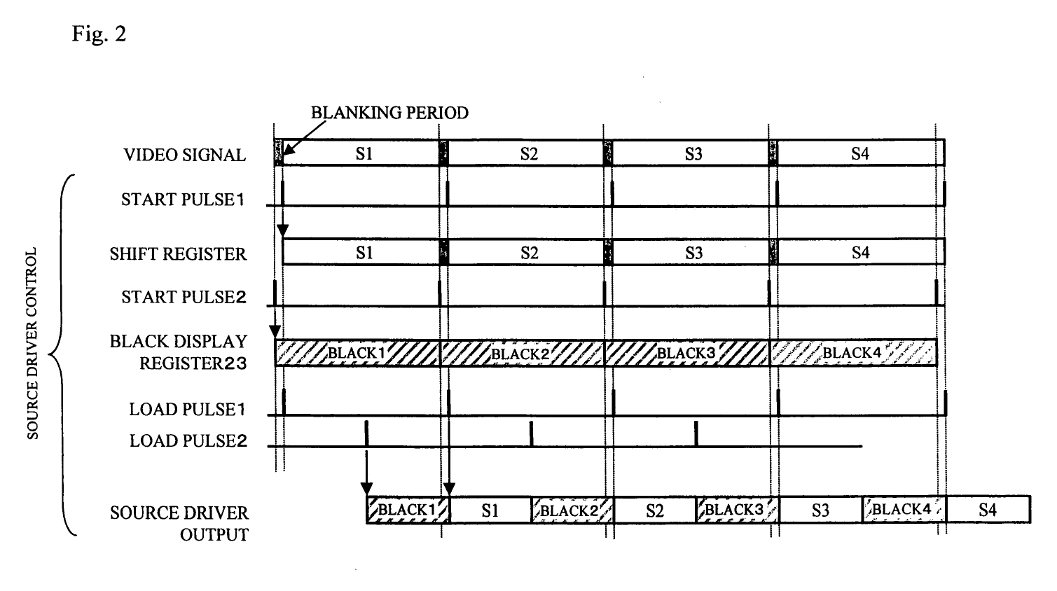

FIG. 2 is a timing chart showing the flow of display data during the driving to prevent transferring from the bend alignment to the spray alignment executed by the liquid crystal display device of Embodiment 1, shown in FIG. 1, so as to insert black display.

Now, with reference to FIGS. 1 and 2, a description will be given of the driving to prevent transferring from the bend alignment to the spray alignment in the liquid crystal display device of Embodiment 1.

A video signal composed of RGB data is inputted to the signal processing section 31 of the controller 13, which then executes a gray level or gamma correction process on the input video signal.

The timing control section 32 of the controller 13 outputs a start pulse 1 when inputting of display signals (S1 to S4) contained in the video signal is started. This allows the start of a transfer of a display signal processed by the signal processing section 31 to the shift register 22. Here, the display signal processed by the signal processing section 31 is sequentially transferred to the shift register 22 without being subjected to double speed conversion. Consequently, the display signal is transferred from the signal processing section 31 to the shift register 22 at the same speed (unchanged speed) as that of the video signal inputted to the controller 13.

The display signal processed by the signal processing section 31 corresponds to an example of video data according to the present invention. The timing at which the timing control section 32 outputs the start pulse 1 corresponds to an example of a first timing according to the present invention. An example of video data input timing control step according to the present invention corresponds to the process in which the timing control section 32 outputs the start pulse 1 to start transferring the display signal to the shift register 22.

The timing control section 32 of the controller 13 outputs a start pulse 2 when a blanking period contained in the input video signal is started. This allows black display data for black insertion to be transferred from the signal processing section. 31 to the black display register 23; the black display data is used to prevent transferring from the bend alignment to the spray alignment. At this time, the black display data for black insertion, generated by the signal processing section 31 on the basis of the gray level information stored in the black gray level storing section 33, is transferred to the black display register 23. The black display register 23 may not comprise such a shift function as provided in the shift register 22; the function of the sift register 22 sequentially stores input data on each pixel and simultaneously outputs the data.

Then, the timing control section 32 of the controller 13 outputs a load pulse 1 to the D/A converter 21 of the source driver 11 before the output of the start pulse 1 for starting the transfer of the next display signal contained in the video signal. At the time of input of the load pulse 1, the D/A converter 21 simultaneously acquires display signal on one-line pixels stored in the shift register 22, executes a D/A conversion on the signal, and outputs a voltage corresponding to each display signal to a signal line in the liquid crystal display panel 10.

The voltage corresponding to each display signal outputted to the signal line in the liquid crystal display panel 10 corresponds to an example of a first voltage according to the present invention. The timing at which the timing control section 32 outputs the load pulse 1 to the D/A converting section 21 corresponds to an example of a second timing according to the present invention.

The timing control section 32 of the controller 13 outputs a load pulse 2 to the D/A converting section 21 of the source driver 11 when black display for preventing transferring from the bend alignment to the spray alignment is inserted during 1H period. At the time of input of the load pulse 2, the D/A converter 21 simultaneously acquires black display data on one-line pixels stored in the black display register 23, executes a D/A conversion on the data, and outputs a voltage corresponding to the black gray level to the signal line in the liquid crystal display panel 10.

The voltage corresponding to the black gray level outputted to the signal line in the liquid crystal display panel 10 corresponds to an example of a second voltage according to the present invention. The timing at which the timing control section 32 outputs the load pulse 2 to the D/A converting section 21 corresponds to an example of a third timing according to the present invention. An example of an output timing control step according to the present invention corresponds to the process in which the timing control section 32 outputs the load pulses 1 and 2 to control the D/A converting section 21.

This process allows the black display data to be outputted to the liquid crystal display panel 10 by the source driver 11 so that the black display data is inserted between the display signals as shown in FIG. 2.

The load pulse 1 is outputted immediately before the next display signal is inputted. Thus, as shown in FIG. 2, when inputting of the display signal S2 contained in the video signal is started, the preceding display signal S1 is outputted by the source driver 11. Thus, the source driver 11 outputs the data to the signal line in the liquid crystal display panel 10 1H period later than the video signal which has been inputted to the controller 13.

The output timing for the load pulse 2 determines the black insertion period. Consequently, varying the output timing for the load pulse 2 enables the adjustment of the ratio of the black insertion period to the display period. Allowing the load pulse 2 to be outputted earlier during the 1H period increases the ratio of the black insertion period. Allowing the load pulse 2 to be outputted later during the 1H period reduces the ratio of the black insertion period.

The display period corresponds to an example of a video display period according to the present invention. The black insertion period corresponds to an example of a predetermined time containing no video display period according to the present invention.

The OCB mode liquid crystal element is known to be more likely to undergo the transferring from the bend alignment to the spray alignment at higher temperatures. For example, the timing control section 32 can vary the output timing for the load pulse 2 and thus the ratio of the black insertion period, on the basis of the temperature of the liquid crystal display panel 10, to thereby provide a liquid crystal display device that can prevent transferring from the bend alignment to the spray alignment in spite of a change in temperature.

Further, since the source driver 11 provides the same output during each black insertion period, the D/A converting section 21 may repeatedly acquire the black display data stored in the black display register 23 so that the source driver 11 can output the data. In FIG. 2, the black display data acquired during the blanking period of each 1H period is used as the next black data to be inserted. However, for example, “black 1” black display data acquired during the blanking period before the display signal S1 may be used as black data to be inserted after the subsequent display signals (S2, S3, . . . ).

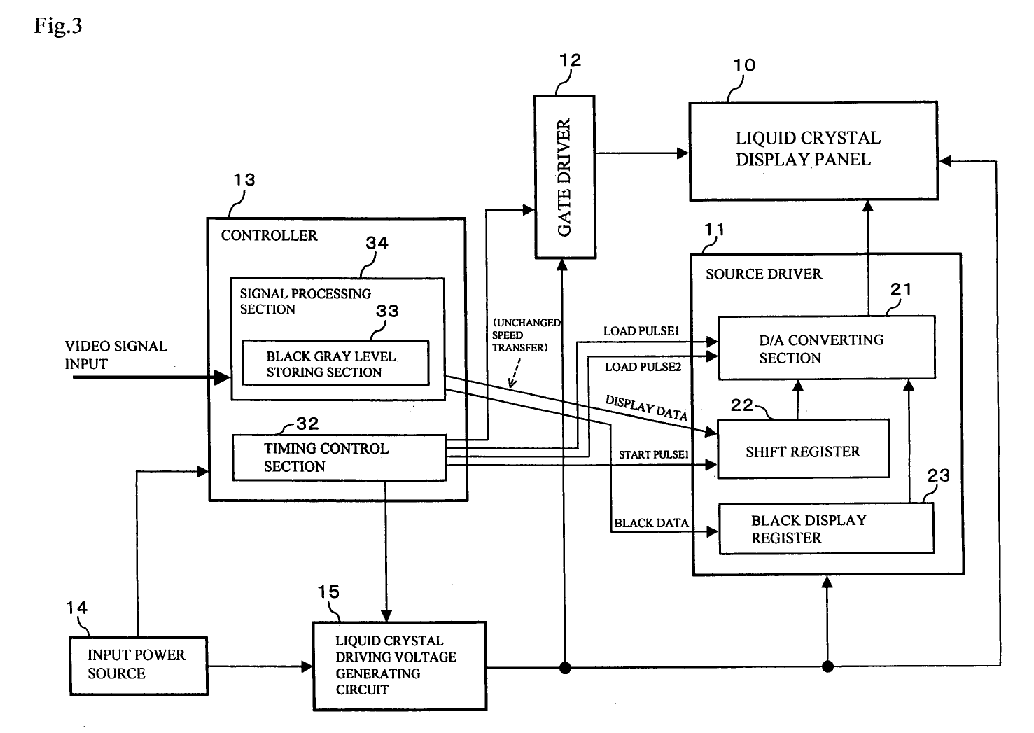

FIG. 3 is a block diagram showing another configuration of the liquid crystal display device of Embodiment 1. The same components as those in FIG. 1 are denoted by the same reference numerals.

The liquid crystal display device in FIG. 3 stores the black display data for black insertion in the black display register 23 when the device is powered on so that the black display data can be displayed on the liquid crystal display panel 10.

The operation of the liquid crystal display device shown in FIG. 3 will be described in terms of differences from the liquid crystal display device shown mainly in FIG. 1.

When the liquid crystal display device is powered on, the signal processing section 34 of the controller 13 generates black display data for black insertion on the basis of the gray level information stored in the black gray level storing section 33, regardless of the presence of a video signal input. The signal processing section 34 then transfers the black display data generated to the black display register 23. In other words, when the liquid crystal display device is turned on, the black display data is transferred once from the controller 13 to the black display register of the source driver 11 and stored therein. The signal processing section 34 corresponds to an example of a second data generating section according to the present invention.

A video signal composed of RGB data is inputted to the signal processing section 34 of the controller 13, which then executes a gray level or gamma correction process on the input video signal.

The timing control section 32 of the controller 13 outputs a start pulse 1 when inputting of display signals (S1 to S4) contained in the video signal is started. This allows the start of a transfer of a display signal processed by the signal processing section 34 to the shift register 22. Here, the display signal processed by the signal processing section 34 is sequentially transferred to the shift register 22 without being subjected to double speed conversion. Consequently, the display signal is transferred from the signal processing section 34 to the shift register 22 at the same speed (unchanged speed) as that of the video signal inputted to the controller 13.

Then, the timing control section 32 of the controller 13 outputs a load pulse 1 to the D/A converter 21 of the source driver 11 before the output of the start pulse 1 for starting the transfer of the next display signal contained in the video signal. At the time of input of the load pulse 1, the D/A converter 21 simultaneously acquires display signal on one-line pixels stored in the shift register 22, executes a D/A conversion on the signal, and outputs a voltage corresponding to each display signal to a signal line in the liquid crystal display panel 10.

The timing control section 32 of the controller 13 outputs the load pulse 2 to the D/A converting section 21 of the source driver 11 when black display for preventing transferring from the bend alignment to the spray alignment is inserted during the 1H period. At the time of input of the load pulse 2, the D/A converting section 21 simultaneously acquires black display data on one-line pixels stored in the black display register 23, executes a D/A conversion on the data, and outputs a voltage corresponding to the black gray level to the signal line in the liquid crystal display panel 10.

The liquid crystal display device shown in FIG. 1 transfers the black display data to the black display register 23 during the blanking period. In contrast, the liquid crystal display device shown in FIG. 3 transfers the black display data to the black display register 23 when powered on, regardless of the input of a video signal. The black display data is transferred only once at the time of power-on. This eliminates the need for the timing control of the timing at which the display data is transferred to the shift register 22 and the timing at which the black display data is transferred to the black display register 23. Thus, the timing control is facilitated.

The liquid crystal display devices of Embodiment 1, shown in FIGS. 1 and 3, use the same black display data on each pixel for inserted black display. Accordingly, black display data on pixels, the number of which is insufficient to constitute one line, may be stored in the black display register 23 so as to be repeatedly used as black display data for insertion of other pixels. In this case, provided that the black display register 23 can store black display data on at least one pixel, it is possible to carry out the method for preventing transferring from the bend alignment to the spray alignment on the basis of black insertion according to Embodiment 1.

Furthermore, the gray level information of the black display data stored in the black gray level storing section 33 can be individually set for R, G, and B. Even with a different liquid crystal display panel 10, the gray level information of the black display data for black insertion can be set with information that is appropriate for the characteristics of the liquid crystal display panel 10.

(Embodiment 2)

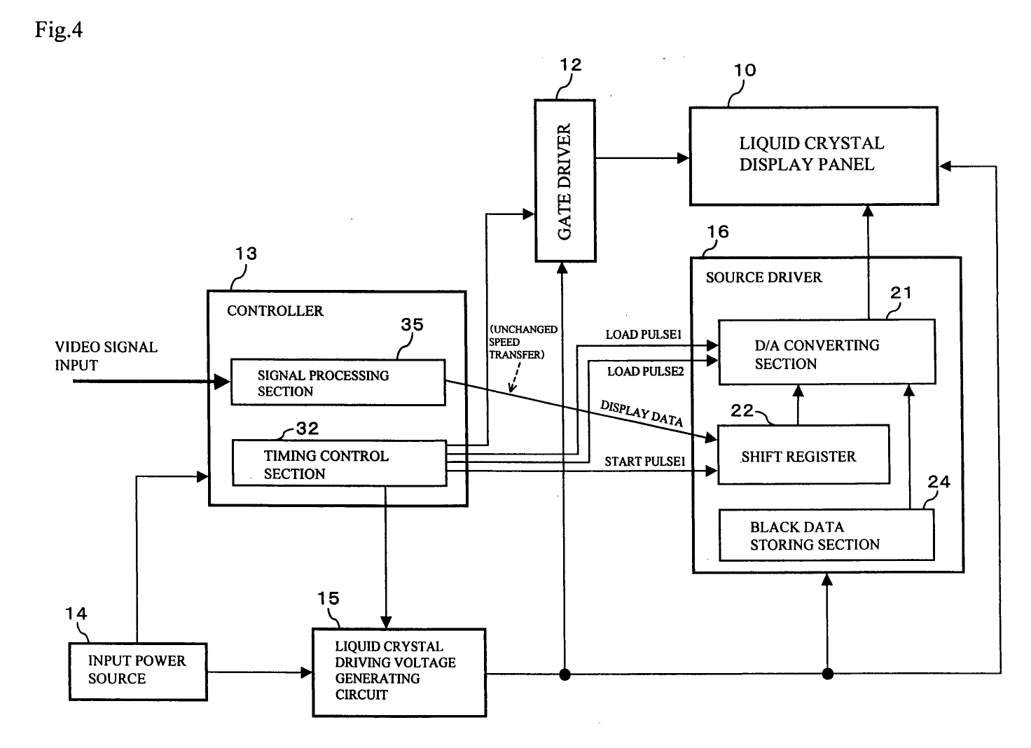

FIG. 4 is a block diagram showing the configuration of a liquid crystal display device according to Embodiment 2 of the present invention.

The liquid crystal display device according to Embodiment 2 is different from the liquid crystal display device according to Embodiment 1 in that the source driver 11 of Embodiment 1, shown in FIGS. 1 and 3, comprises a black display register 23 instead of a black data storing section 24.

The black data storing section 24 is a ROM in which black display data for black insertion on one-line pixels is pre-stored. The other arrangements are the same as those of the liquid crystal display device of Embodiment 1, shown in FIG. 1. The description of these arrangements is thus omitted. The black data storing section 24 corresponds to an example of a second data storing section in which second data is pre-stored according to the present invention.

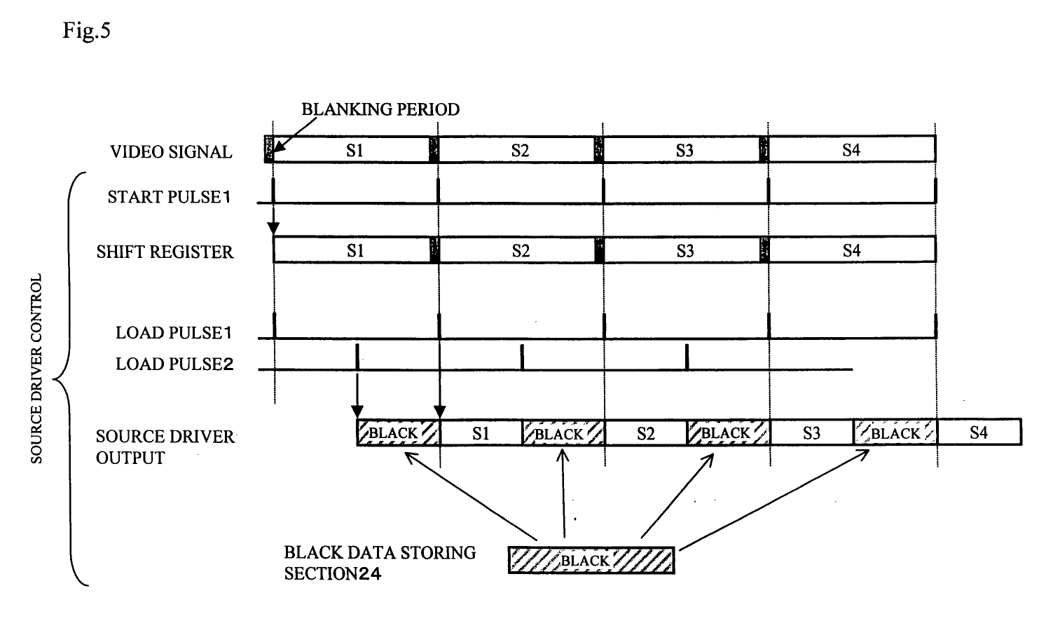

FIG. 5 is a timing chart showing the flow of display data during the driving to prevent transferring from the bend alignment to the spray alignment executed by the liquid crystal display device of Embodiment 2, shown in FIG. 4, so as to insert black display.

Now, with reference to FIGS. 4 and 5, description will be given of the driving to prevent transferring from the bend alignment to the spray alignment in the liquid crystal display device of Embodiment 2.

A video signal composed of RGB data is inputted to a signal processing section 35 of the controller 13, which then executes a gray level or gamma correction process on the input video signal.

The timing control section 32 of the controller 13 outputs the start pulse 1 when inputting of display signals (S1 to S4) contained in the video signal is started. This allows the start of transfer of a display signal processed by the signal processing section 35 to the shift register 22. Here, the display signal processed by the signal processing section 35 is sequentially transferred to the shift register 22 without being subjected to double speed conversion. Consequently, the display signal is transferred from the signal processing section 35 to the shift register 22 at the same speed (unchanged speed) as that of the video signal inputted to the controller 13. The timing at which the timing control section 32 outputs the start pulse 1 is the same as that at which the timing control section 32 outputs the start pulse 1 according to Embodiment 1.

An example of a video data input timing control step according to the present invention corresponds to the process in which the timing control section 32 outputs the start pulse 1 so that the display signal starts to be outputted to the shift register 22.

Then, the timing control section 32 of the controller 13 outputs the load pulse 1 to the D/A converter 21 of the source driver 11 before the output of the start pulse 1 for starting the transfer of the next display signal contained in the video signal. At the time of input of the load pulse 1, the D/A converter 21 simultaneously acquires display signal on one-line pixels stored in the shift register 22, executes a D/A conversion on the signal, and outputs a voltage corresponding to each display signal to the signal line in the liquid crystal display panel 10.

The timing control section 32 of the controller 13 outputs the load pulse 2 to the D/A converting section 21 of the source driver 11 when black display for preventing transferring from the bend alignment to the spray alignment is inserted during the 1H period. At the time of input of the load pulse 2, the D/A converting section 21 simultaneously acquires black display data on one-line pixels stored in the black data storing section 24 in advance, executes a D/A conversion on the data, and outputs a voltage corresponding to the black gray level to the signal line in the liquid crystal display panel 10. The timings at which the timing control section 32 outputs the load pulses 1 and 2 is the same as those at which the timing control section 32 outputs the load pulses 1 and 2 according to Embodiment 1.

An example of an output timing control step according to the present invention corresponds to the process in which the timing control section 32 outputs the load pulses 1 and 2 to control the D/A converting section 21.

This process allows the black display data to be outputted to the liquid crystal display panel 10 by the source driver 11 so that the black display data is inserted between the display signals as shown in FIG. 5.

As shown in FIG. 5, the load pulse 1 is outputted immediately before the next display signal is inputted, consequently the timing at which the data is outputted from the source driver 11 to a signal line in the liquid crystal display panel 10 is 1H later timing than the video signal that has been inputted to the controller 13.

The output timing for the load pulse 2 determines the black insertion period. Consequently, varying the output timing for the load pulse 2 enables the adjustment of the ratio of the black insertion period to the display period. Allowing the load pulse 2 to be outputted earlier during the 1H period increases the ratio of the black insertion period. Allowing the load pulse 2 to be outputted later during the 1H period reduces the ratio of the black insertion period.

In Embodiment 2, the black data storing section 24 stores black display data for black insertion on one-line pixels. However, since the same black display data on each pixel is used for inserted black display, black display data on pixels, the number of which is in sufficient to constitute one line, may be stored in the black data storing section 24 in advance so as to be repeatedly used as black display data. In this case, the present invention can be achieved, provided that the black data storing section 24 can store black display data on at least one pixel in advance.

In Embodiment 2, the black data storing section 24 is a ROM. However, other elements may be used, provided that black display data corresponding to inserted black display can be pre-stored in the elements. For example, a hardware configuration may be used in which a circuit fixedly outputs a black display data value.

As described above, the conventional driving to prevent transferring from the bend alignment to the spray alignment based on the double-speed conversion must transfer a display signal from the controller to the source driver at a high speed (double speed). In contrast, the same transfer can be achieved at a lower speed (unchanged speed) by using the liquid crystal display device and the method for controlling display data for the liquid crystal display device according to the present invention. This enables a reduction in the power consumed by the controller and source driver. The present invention also avoids unwanted noise conventionally resulting from the high frequency of the high-speed transfer between the controller and the source driver.

The present invention also eliminates the need for a line memory conventionally required for the driving to prevent transferring from the bend alignment to the spray alignment based on the double-speed conversion. The present invention only requires the black insertion data storing section to be added; the black insertion data storing section can be obtained by slightly changing the conventional circuit configuration. This reduces costs. Furthermore, the double-speed conversion, which operates at a high speed, is not required, thus eliminating the need for a high-performance element for the controller. This also enables a reduction in costs.

In the description of the above embodiments, the black data for black insertion for preventing the transferring from the bend alignment to the spray alignment is displayed on the liquid crystal display panel using the OCB mode liquid crystal element. However, the liquid crystal display device and its control method, configured as described above, are applicable to the insertion of the black data for the improved motion picture quality. Not only with the liquid crystal panel using the OCB mode liquid crystal display element but also with liquid crystal panels using other liquid crystal elements, the configurations shown in the embodiments in FIGS. 1, 3, and 4 enable the insertion of the black data for the improved motion picture quality.

If the black data is inserted to improve the motion picture quality, the motion picture quality is improved by increasing the ratio of the black insertion period, during which the black data is displayed, to the display period, during which the display data is displayed.

For the black data described in the embodiments, it is possible to provide plural types of predetermined gray scale of picture data in place of one type of gray scale of picture data corresponding to the black video display. An increase in the rate of black data inserted improves the motion picture quality but correspondingly reduces luminance. For example, in displaying a still image, the luminance can be increased by replacing the black data to be inserted with other gray scale of picture data. In other words, by providing plural gray scale of picture data as data to be inserted into the display data, and changing the gray scale of picture of the data to be inserted as required, it is possible to provide display suitable for that scene.

A program related to the present invention allows a computer to execute the output timing control step of controlling timings such that during the video display period, a D/A conversion is executed on the video data stored in the shift register to allow the first voltage to be supplied to the signal line and such that during the predetermined period, a D/A conversion is executed on the second data stored in a second data storing section to allow the second voltage to be supplied to the signal line, the output timing control step being included in the method for controlling display data for a liquid crystal display device according to the present invention, the program operating in cooperation with the computer.

The present invention also provides recording media on which a program is recorded, which program allows a computer to execute operation in the output timing control step of controlling timings such that during the video display period, a D/A conversion is executed on the video data stored in the shift register to allow the first voltage to be supplied to the appropriate signal lines and such that during the predetermined period, a D/A conversion is executed on the second data stored in a second data storing section to allow the second voltage to be supplied to the signal line, the output timing control step being included in the method for controlling display data for a liquid crystal display device according to the present invention. The recording media is readable by the computer, and the program read from the recording media is used in cooperation with the computer.

According to an aspect of the program related to the present invention, the program may be recorded on recording media readable by the computer and that operates in cooperation with the computer.

The recording media includes a ROM.

The computer according to the present invention is not limited to pure hardware such as a CPU but may be firmware, an OS, or peripheral equipment.

As described above, the present invention may be configured on the basis of either software or hardware.

Power consumption can be reduced by the liquid crystal display device, the method for controlling display data for the liquid crystal display device, and the like according to the present invention, which are thus useful for liquid crystal display devices using an OCB mode liquid crystal or the like and methods for controlling display data for these liquid crystal display devices.

Clearly, numerous modifications and variations of the present invention are possible in light of the above teachings. It is therefore to be understood that within the scope of the appended claims, the invention may be practiced otherwise than as specifically described herein.

What is claimed is:

1. A liquid crystal display device comprising:
a liquid crystal display panel having signal lines and scan lines arranged in a matrix, and pixel electrodes each provided in association with an intersection point between the corresponding signal line and scan line;
a gate driver configured to supply a gate signal to any of the scan lines;
a source driver having a shift register to which video data to be displayed during a video display period is sequentially inputted, the video data corresponding to pixels in one line, the shift register configured to simultaneously output video data corresponding to pixels in one line, a second data storing section configured to store second data which are applied to each of the pixel electrodes and which are independent of the video data, and a D/A converting section configured to execute a D/A conversion on the video data acquired from the shift register and the second data acquired from the second data storing section and to supply a voltage to the signal line; and
a timing control section configured to control a first timing at which the video data contained in an input video signal is inputted to the shift register, to control a second timing at which the D/A converting section acquires the video data from the shift register and executes a D/A conversion on the video data and supplies a voltage to the signal line, and to control a third timing at which the D/A converting section acquires the second data from the second data storing section, executes a D/A conversion on the second data, and supplies a voltage to the signal line.

2. The liquid crystal display device according to claim 1, wherein the second data allows at least one of a plurality of different predetermined gray levels to be displayed.

3. The liquid crystal display device according to claim 1, wherein the second data is black data to be displayed during a black insertion period in a normally white mode.

4. The liquid crystal display device according to claim 3, wherein a liquid crystal used in the liquid crystal display panel is an OCB mode liquid crystal.

5. The liquid crystal display device according to claim 1, further comprising a second data generating section configured to generate the second data,
wherein the timing control section is configured to control such that the second data generated by the second data generating section is inputted to the second data storing section during a blanking period of the input video signal.

6. The liquid crystal display device according to claim 5, wherein the second data generating section is configured to generate the second data from individually set gray level data on R, G, and B.

7. The liquid crystal display device according to claim 1, further comprising a second data generating section which, when a power supply is turned on, is configured to generate and input the second data to the second data storing section regardless of the input of the video signal.

8. The liquid crystal display device according to claim 7, wherein the second data generating section is configured to generate the second data from individually set gray level data on R, G, and B.

9. The liquid crystal display device according to claim 1, wherein the second data in the second storing section is pre-stored.

10. A method for controlling display data for a liquid crystal display device including a liquid crystal display panel having signal lines and scan lines arranged in a matrix, and pixel electrodes each provided in association with an intersection point between the corresponding signal line and scan line, a gate driver configured to supply a gate signal to any of the scan lines, and a source driver configured to supply a first voltage corresponding to a gray level in video data, to the signal line during a video display period, and to supply a second voltage, corresponding to a gray level in second data independent of the video data, to the signal line during a predetermined period containing no video display period, the method comprising:
a video data input timing control step of controlling a timing at which the video data contained in an input video signal is inputted to a shift register provided in the source driver and to which the video data to be displayed during the video display period is sequentially inputted, the video data corresponding to pixels in one line, the shift register simultaneously outputting video data corresponding to pixels in one line; and
an output timing control step of controlling timings, such that during the video display period, a D/A conversion is executed on the video data stored in the shift register to allow the first voltage to be supplied to the signal line, and such that during the predetermined period a D/A conversion is executed on the second data stored in a second data storing section provided in the source driver to allow the second voltage to be supplied to the signal line.

11. The method for controlling display data for a liquid crystal display device according to claim 10, wherein the second data allows at least one of a plurality of different predetermined gray levels to be displayed.

12. The method for controlling display data for a liquid crystal display device according to claim 10, wherein the second data is black data to be displayed during a black insertion period in a normally white mode.

13. The method for controlling display data for a liquid crystal display device according to claim 12, wherein a liquid crystal used in the liquid crystal display panel is an OCB mode liquid crystal.

14. A computer readable storage medium on which a program is recorded, which when the program is executed allows a computer to function so as to execute the output timing control step of controlling timings such that during the video display period, a D/A conversion is executed on the video data stored in the shift register to allow the first voltage to be supplied to the signal line and such that during the predetermined period, a D/A conversion is executed on the second data stored in a second data storing section so as to allow the second voltage to be supplied to the signal line, the output timing control step being included in the method for controlling display data for a liquid crystal display device according to claim 10.
